(19) United States
(12) Patent Application Publication
(10) Pub. No.: US 2006/0158981 A1
(43) Pub. Date: Jul. 20, 2006

(54) Method for two dimensional control of mark size on an optical disc, write strategy for such a method, recording medium and recorder using two dimensional control of mark size

(76) Inventors: Erwin Rinaldo Meinders, EINDHOVEN (NL); Joachim Wilhelm Hellmig, Eindhoven (NL); Gerardus Rudolph Langereis, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/547,323

(22) PCT Filed: Mar. 3, 2004
(86) PCT No.: PCT/IB04/50190

§ 371 Date: Aug. 30, 2005

(30) Foreign Application Priority Data
Mar. 4, 2003 (EP) 03075670.4

(51) Int. Cl. G11B 5/09; G11B 7/00

(52) U.S. Cl. 369/47.5; 369/116; 369/59.1

(57) ABSTRACT

An optical recording method is disclosed for writing a two-dimensional data pattern in a phase-change disc, i.e. a optical disc with a phase change material. The effect of thermal cross-erase is used by using the sides of the diffraction limited laser spot to heat up the adjacent track such that previously written data are partly erased. The amount of erasure is well controlled by the applied write strategy and determines the final mark size by erasing the side of the mark facing the laser spot. The mark can be initially written with a laser spot that results in a mark size that is larger than desired and subsequently, when marks in an adjacent track are being recorded, reduced in size by erasing the sides of the mark by irradiating the sides of the mark with the sides of the diffraction limited laser spot that is focused on the adjacent track.

The invention relates to a method of recording information on an optical disc comprising irradiating a first region of the optical disc with a first dose of optical energy, irradiating a first portion of the first region with a second dose of optical energy in a manner that causes the first portion of the first region irradiated with the second dose of optical energy to be in a different state than a second portion of the first region that is not irradiated by the second dose of optical energy, a write strategy processor arranged to generate control signals for writing data to an optical disc comprising a processor arranged to specify a first optical pulse for irradiating a first region of the optical disc with a first dose of optical energy and a second optical pulse for irradiating a first portion of the first region with a second dose of optical energy in a manner that causes the first portion of the first region irradiated with the second optical dose to be in a different state than a second portion of the first region that is not irradiated by the second dose of optical energy, a recorder for recording optical discs comprising a write strategy processor, and an optical disc.

Such a method is known from WO 01/13365 where a method is disclosed to record multi level information by accurate control of two levels of the laser energy dose applied to regions on the optical disc. The first level of laser energy is applied to melt a first region of the recording material while the second level of laser energy is used to re-crystallize a portion of the first region. This allows an amorphous mark to be formed within the first region that is smaller than the region itself because the second re-crystallized portion effectively reduces the amorphous portion of the region. This allows the recording of multi level data because of the control of the length of the amorphous area. However even higher data densities are required which the disclosure of WO 01/13365 cannot provide.

It is therefore the objective of the invention to provide a higher data density than is possible by control of the length.

This objective is achieved in that the invention is characterized in that a third portion of the first region which is comprised in the second portion of the first region, where the third portion is adjacent to the second region, is irradiated with a third dose of optical energy when a portion of a second region which is adjacent to the first region is irradiated with the third dose of optical energy in a manner that causes the third portion of the first region irradiated with the third dose of optical energy to be in a different state than the second portion of the first region that is not irradiated by the third dose of optical energy.

The third portion allows a further degree of control, in addition to the control by the first portion, of the size of the amorphous mark. The first portion is used for control directly after the writing of the amorphous mark by applying a second dose of optical energy to a portion of the amorphous mark thus enabling a partial erase by re-crystallization of the first portion of the amorphous region. This limits the control to the length of the mark. The third portion is along the edge of the mark. This allows the erase or recrystallization of the third portion by the optical energy that is applied to an adjacent region. The optical energy is not precisely limited to the adjacent region but overlaps slightly with the amorphous mark. While re-crystallizing the adjacent region the energy level for the recrystallization can be adjusted such that the third region is irradiated at the same time with a dose sufficient to also re-crystallize the third region. This allows an even more precise control of the size of the second region because both the first region and the second region can be independently used to reduce the amorphous region in size from two sides. The amorphous mark can thus be smaller compared to when the control of the size of the amorphous region is only effected through the first region and more data can thus be fitted onto the optical disc.

A new method recently introduced is two-dimensional data storage in one plane The anticipated data capacity gain is estimated to be at least a factor 1.5. The method is based on a two-dimensional pattern of pre-mastered pits that represent encoded data. A multi-spot readout unit is used to retrieve the information.

The method according to the invention can be used to record such two-dimensional patterns and thus provide for a disc with higher data densities as obtained through two-dimensional data storage. An increased data density would be especially beneficial for a small form factor optical disc.

An embodiment of the invention is characterized in that the third dose of optical energy is adjusted to control a size of the third portion of the first region. In addition to only reducing the size of the amorphous mark the increased precision can be used to provide more levels for multi level recording, resulting in more data being stored. The third portion allows a more precise trimming of the size of the amorphous mark as is required for multi level recording.

A further embodiment of the invention is characterized in that the third dose of optical energy is adjusted to control a size of the second portion of the first region.

By re-crystallization of the third region, the size of the amorphous mark is reduced. In addition to only reducing the size of the amorphous mark the increased precision can be used to provide more levels for multi level recording, resulting in more data being stored. The third portion allows a more precise trimming of the size of the amorphous mark as is required for multi level recording.

A further embodiment of the invention is characterized in that the second region is located adjacent to the first region in a direction perpendicular to a writing direction. When the second region is located adjacent to the first region perpendicular to the writing direction, the second region is written at a later point in time than the first region. This allows the re-crystallization of the amorphous mark after the amorphous mark was written. Because the first region is adjacent to the second region the partial overlap by the optical beam with the first region the third portion of the first region can be re-crystallized during the re-crystallization of portions of the second region.

A further embodiment of the invention is characterized in that the first region is located on a first track and the second region is located on a second track which is adjacent to the first track. The first region and the second region can be located on separate tracks on the optical disc. If there is a single track on the optical disk each section of the track can be regarded as a separate track when observed locally.

A further embodiment is characterized in that a first optical beam is used to irradiate the first region while a second optical beam is used of irradiate the second region.

By using multiple beams a higher recording speed can be obtained. Additionally the thermal effects of the writing of the amorphous region by the first optical beam can be used when later crystallizing the third portion of the first region when the adjacent region is re-crystallized. For instance the remaining heat in the first region allows a reduction of the optical power dose of the second optical beam required for re-crystallizing the third portion of the first region.

A further embodiment is characterized in that a first optical beam is offset in the writing direction from the second optical beam. An offset between the first optical beam and the second optical beam allows the first region to cool down a certain amount, depending on the amount of offset, before the re-crystallization of the third portion by the second optical beam takes place.

A further embodiment is characterized in that the offset between the first optical beam and the second optical beam is related to a thermal interference between the first region and the second region. The offset can be adjusted, either statically or dynamically, to the thermal properties of the recording medium. There is thermal interference between adjacent regions that transports heat from a region just written to a region still to be written or erased. An optimum offset thus determined allows the optical energy dose applied by the second optical beam to be optimized.

The invention will now be described in figures.

A writing strategy processor according to the invention is characterized in that the processor is arranged to specify a third optical pulse for irradiating a second region of the optical disc, adjacent to the first region, such that a third portion of the first region where the third portion is adjacent to the second region, comprised in the second portion of the first region, is also irradiated with a third optical dose in a manner that causes the third portion of the first region irradiated with the third optical dose to be in a different state than a second portion of the region that is not irradiated by the second dose of optical energy. The use of a writing strategy processor allows the generation of the appropriate first optical pulses, the optical writing pulses, and the second optical pulses, the optical erasure pulses. Because the writing strategy processor knows what was written in the regions adjacent to the region to be written the level and duration of the writing and erasure pulses can be adjusted to not only write the desired amorphous mark in the present region to be recorded, but also to reduce the size of the amorphous mark in the adjacent region.

An optical recording method is disclosed for writing a two-dimensional data pattern in a phase-change disc, i.e. a optical disc with a phase change material. Since the method is based on phase-change technology, data can be written numerous times and in a direct-overwrite mode. The two-dimensional data pattern is preferably written with one laser spot, but the application of multiple light sources that can be modulated independently is not excluded and can be equally applied with the present invention. In case of the single laser spot, the effect of thermal cross-erase is utilized. That effect was the radial density limiting factor in the old land/groove recording medium (for instance the former DVD or Blu-ray Disc technology). Contrary to those technologies the effect of thermal cross-erase is used by using the sides of the diffraction limited laser spot to heat up the adjacent track such that previously written data are partly erased. The amount of erasure is well controlled by the applied write strategy and determines the final mark size. The mark can be initially written with a laser spot that results in a mark size that is larger than desired and subsequently, when marks in an adjacent track are being recorded, reduced in size by erasing the sides of the mark by irradiating the sides of the mark with the sides of the diffraction limited laser spot that is focused on the adjacent track.

The invention will now be described based on figures.

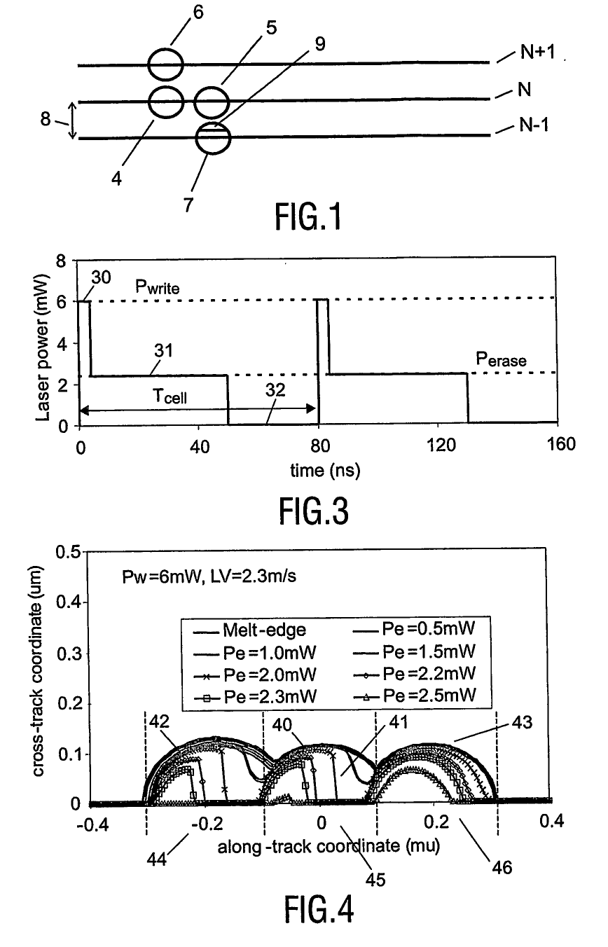

FIG. 1 shows a mark in an adjacent track being partially erased by writing in the central track.

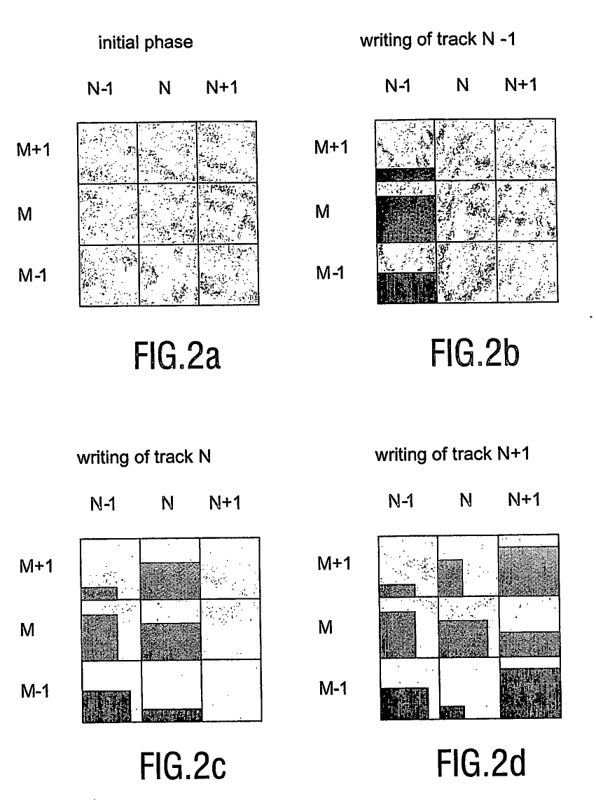

FIG. 2 shows a scheme for 2D multi-level recording.

FIG. 3 shows a simulation result of multi level recording in a central track.

FIG. 4 shows a simulation result of multi level recording in a central track.

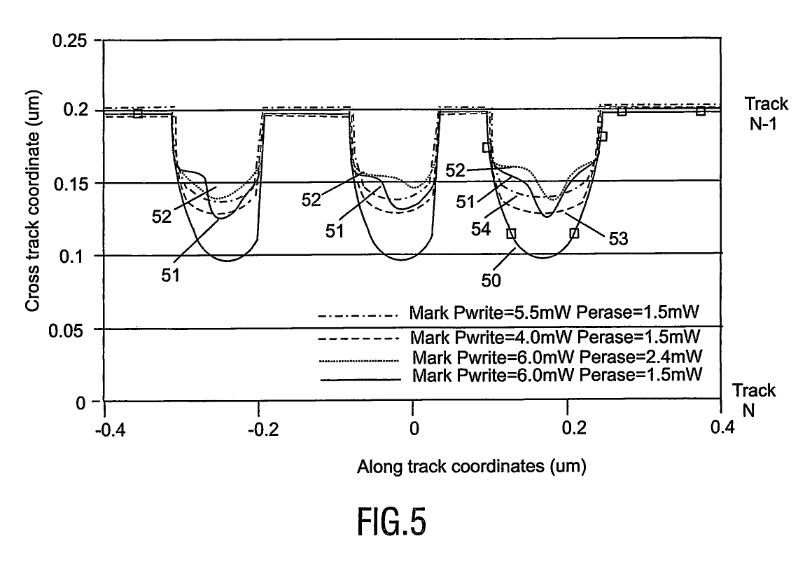

FIG. 5 shows simulation results of the calculated mark shapes in the adjacent tracks due to partial re-crystallization.

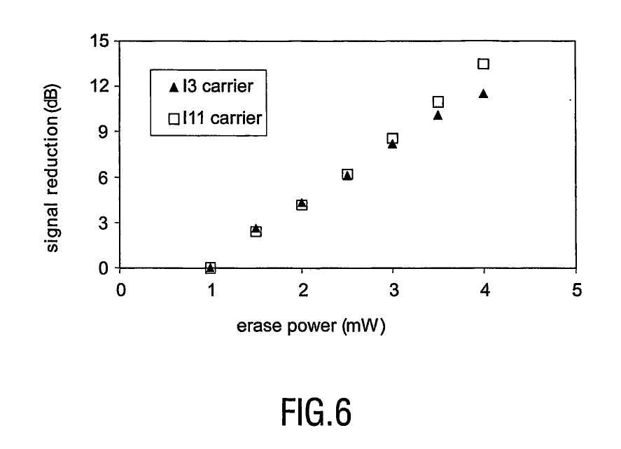

FIG. 6 shows the signal reduction of I3 and I11 carrier written in the central track due to continuous heating of the adjacent track.

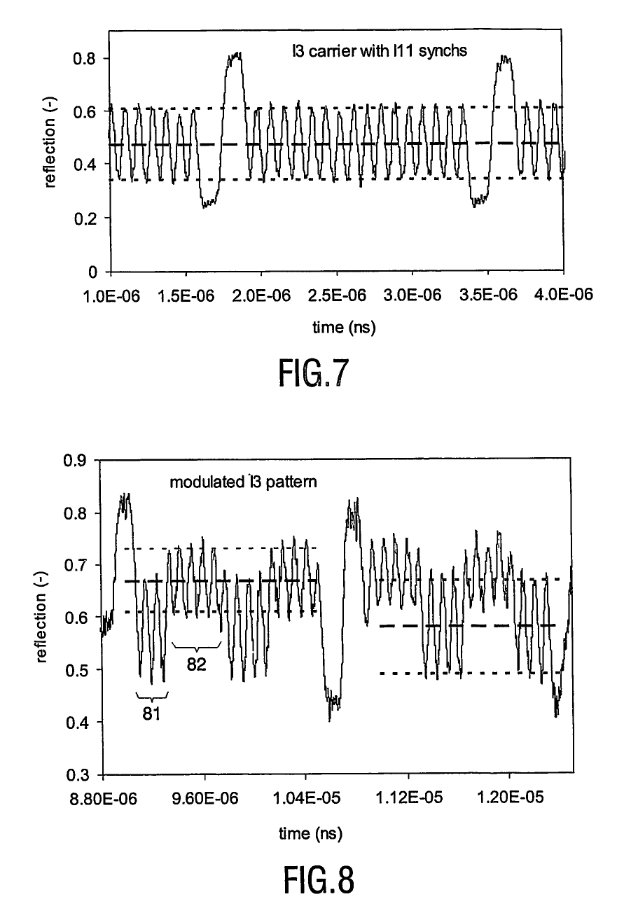

FIG. 7 shows the measured initial reflection of an I3-I11 data pattern written in a central track of a BD disc.

FIG. 8 Measured reflection of the I3-I11 data pattern after application of a block-shaped erasure in the adjacent track with two different erase power levels.

FIG. 1 shows a mark in an adjacent track being partially erased by writing in the central track.

The main idea is to write marks 4, 5 in the central track N and simultaneously partly erase the marks 6, 7 in the adjacent tracks N−1, N+1. The mark is a first state in which the material of the medium In this way, data are written in track N while data written in the adjacent track N−1 are partly erased. The measured reflection from track N comprises the contribution from adjacent tracks N−1, N+1 as well (optical cross-talk). The spot intensity is typically a Gauss (something between a Gauss and Airy). The stack response should therefore be seen as a convolution of the intensity profile and the present data. Typically, the marks 4, 5 in the central track N will have a more significant contribution to the total reflected signal than the marks 6, 7 in the adjacent tracks N−1, N+1. In most optical recording application, the contribution from the side tracks N−1, N+1 is unwanted, but the system according to the present invention is designed such that it can cope with optical cross-talk, for instance by using channel coding. The amount of optical cross-talk is determined by the track pitch 8. The track pitch is much smaller than the diffraction limit, which is chosen to go beyond the conventional thermal cross-erase (cross-write) limit, consequently increasing the data capacity even further, and will cause an enlarged optical cross-talk. Using the erasure of the side 9 of a mark 7 on adjacent track N−1, entire two-dimensional data pattern can be written. The erasure of a side section 9 of the mark 7 of the track N−1 resulting in partial erasure of the mark 7 when data are written in track N will lead to a coupled process. Therefore, the write strategy has to be optimized for a number of adjacent tracks N−1, N +1. Due to the fact that the optical (thermal) spots overlaps in the tangential (longitudinal) direction as well, also an optimization with more subsequent cells (at least three) is required. The optical spot used for writing the marks 4, 5, 6, 7 can be round or elliptical and consequently the cells will be symmetric in radial and tangential direction or vice versa. For a round spot it is sufficient for the write strategy to consider a symmetric pattern of 3 by 3 cells.

Synchronization of marks 4, 5, 6, 7 is very important since the mark 6, 7 in the adjacent tracks N−1, N+1 need to be placed with high spatial accuracy with respect to marks in central track N. This can be solved by using known techniques to achieve high spatial accuracy:
1. Pre-mastered lands or spikes for synchronization.
2. Written long (e.g. 120) marks that enable the reconstruction of the synchronization pattern.

Synchronization is done by measuring the long syncs in the adjacent track via optical cross talk. Since the track pitch is much smaller than the optical spot size (diffraction limit), it is expected that the adjacent marks will be detected when focusing on the central track.

FIG. 2 shows a scheme for 2D multi-level recording. In a conventional optical recording system, typically two reflection levels are encountered, namely that of the unwritten state (the high reflection state), i.e. a land, and the written state (low reflection state), i.e. a mark. Full modulation will lead to two distinct reflection levels while incomplete modulation in encountered, in particular for the shortest marks. The information is then embedded in the run-length of the marks and spaces, i.e. the well known run-length modulation.

This run-length modulation scheme can be used to write 2D data pattern, but the possible reflection levels are too numerous. A better recording scheme is by fixing the cell-length and vary the reflection in a cell by modification of the mark size in a cell. A cell is defined as a location where a mark can be written. This is known as the better amplitude modulation method.

A scheme for 2D multi-level recording is shown in FIG. 2 through 2d. FIG. 2a shows a rectangular grid, but a hexagonal structure, i.e. honeycomb structure may be possible as well. In the initial phase, shown in FIG. 2a, the matrix of 9 cells, indicated by the tracks N−1, N and N+1 and the subsequent cells M−1, M and M+1, are unwritten (also track N−2 is unwritten). In step 1, shown in FIG. 2b, data is written in track N−1 with a pulse strategy with the result shown in FIG. 2b. It should be noted that re-crystallization in the tail of the mark is used to control the mark size in the writing direction, i.e. the length of the mark, and thus controlling the resulting reflection level since not every cell has an equal length mark recorded in it. In cell M−1 in track N−1 the mark fills about 50% of the cell while in cell M in track N−1 the mark fills about 75% of the cell. In step 2, as shown in FIG. 2c, data is written in track N. Thermal cross-erase will cause partial erasure of the data written in the previous cycle in track N−1. The result is a reduction in mark size perpendicular to the writing direction, and thus the resulting reflection level is changed. The amount of change is a function of the applied power during writing in N. In step 3, shown in FIG. 2d, data is written in track N+1. Re-crystallization will occur in the tail of the written marks but also in the mark in the adjacent track N. This example illustrates that the mark size can be controlled both in the width and the length of the mark by a proper selection of the write strategy. Parameters to control the size of the mark are consequently the pulse times and pulse powers, P_{write}, Pₑᵣₐₛₑ etc. used to record the track on which the mark is recorded but also the pulse times and pulse powers, P_{write}, Pₑᵣₐₛₑ etc. used to record the adjacent track. The thermal cross-erase only extends to one previous track. The write strategy needs therefore be optimized for three adjacent tracks N−1, N and N+1 and at least for three subsequent cells (M−1, M and M+1), resulting in the 9 cells shown in FIG. 2a through 2d.

It is necessary to write also track N+1 to measure the final reflection levels on track N. Otherwise the non-erased marks on track N+1 would result in different reflection levels for track N.

In this example a square grid is considered in which the columns N−1, N and N+1 denote data tracks and the rows are the separated data cell. The matrix of 9 cells (constellation) is unwritten in the initial phase (panel a). First, data are written in track N−1 according to the described multi-level method. In step 2, data are written in track N, data in track N−1 are partly erased. In step 3, data are written in track N+1, data are partly erased in track N.

FIG. 3 shows the write strategy used to write marks of different size in a fixed cell length.

Here the write strategy for writing two cells is shown. The period T_{cell} is fixed to 80 ns, the cell length was then 183 nm at a linear velocity of LV=2.3 m/s. To reduce the computational effort, only three multi-level cells were considered in the simulation, the three cells are preceded and followed by an erase level Pₑᵣₐₛₑ for thermal compensation, the so called preheat and post heat effects. It is noted that the mark in the central cell is directly heated by the laser spot to write cell 1 and cell 3, while heat diffusion through the stack extends to more than the adjacent in-track cells. Therefore, the central mark is the most relevant cell in our simulation. The length of the write pulse 30 was chosen to be 4 ns, the length of the erase pulse 31 was chosen to be 46 ns, and the length of the bias 32 was chosen to be 30 ns. The write power of the write pulse 30 was fixed to 6 mW while the erase level of the erase pulse 31 was varied for the different simulation runs.

FIG. 4 shows a simulation result of multi level recording in a central track. FIG. 4 shows calculated shapes of marks 40, 42, 43 for a recording scheme in which the length of the cells 44, 45, 46 is fixed and the reflection level is changed by writing marks 40, 42, 43 of different size.

It should be noted that both FIG. 4 and 5 only show that half of the actual mark shape facing the adjacent track from where the re-crystallization is effected. In this example, the erase power was varied to control the re-crystallization in the tail of the amorphous mark 40 such that marks of different size result. Shown are the calculated marks shapes at a recording (linear) velocity of LV=2.3 m/s.

As indicated above, we focus on the crystallization phenomena in the central cell 45 where a mark 40 is recorded. FIG. 4 shows an increased erase level leads to more re-crystallization in the tail 41 of the mark 40 in the central cell 45. This re-crystallization is a well-known phenomenon from phase-change recording and is typically used to write marks that are in the tangential direction, i.e. in the direction of the recording, smaller than the optical spot size. From the simulations it is clear that the erase power variation leads to a significant difference in the re-crystallization in the tail 41 of the mark 40. A similar effect can be achieved by variation in the erase pulse length. Variation in power and duration of the write pulse can also be used to control the size of the written mark 40. Less write power leads to a smaller molten area and thus smaller mark 40, but re-crystallization in the cooling-down phase of the stack can also be used to control the size and shape of the mark 40. It is clear from FIG. 4 that the optical, and thermal, spot extends to the previous and next cell. Therefore, the write strategy should be optimized for a cluster of cells 44, 45, 46 considering at least three cells and possibly more cells along the track. It should be noted that in FIG. 4, even though the erase power is varied only the length of the mark 40 in the cell 45 is reduced and the width of the mark stays virtually constant, only decreasing for higher erase power levels because at those high erase power levels the circular shape of the originally written mark starts to determine the end width of the mark.

For one recording track, the number of distinct reflection levels depends on the detectable levels. There are more levels possible if in addition to the length of the mark also the width of the mark can be varied than when only the length of the mark can be equidistantly varied. If in addition marks are written in the adjacent tracks, this will lead to variation of the distinct reflection levels resulting in more available levels for multi level recording.

FIG. 5 Simulation results of the calculated mark shapes in the adjacent tracks due to partial re-crystallization induced by the laser spot used to write marks in the adjacent tracks. Shown are the initial mark shape 50, calculated mark shapes 51, 52 for different erase powers and mark shapes 53, 54 calculated with different write powers and fixed erase level.

Numerical simulation were also performed to study the effect of thermal cross-erase, i.e. the partial re-crystallization of marks in the adjacent track due to writing in the central track. The initial marks 50 were calculated in a preceding run with the write strategy as shown in FIG. 3. These marks 50 were assumed to be present in the adjacent track at a track pitch of TP=200 nm. In the next write cycle, data were written in the central track, again according to the writing scheme shown in FIG. 2a through 2d. The calculated mark shapes 51, 52, 53, 54 in the adjacent track (at TP=200 nm) after partial re-crystallization (thermal cross-erase) are shown in FIG. 5. The marks written in the central track are not shown but are similar to the results given in FIG. 4. The initial mark shape 50 is indicated with the solid line with square markers in FIG. 5. The marks 51, 52 as a function of erase power (Pₑᵣₐₛₑ between 2.4 and 1.5 mW) are indicated by a solid curve and a high density dashed curve. The mark shapes 53, 54 that result for variable write power and a fixed erase level (P_{write} between 6.0 mW and 4.0 mW) are indicated by a low density dashed curve and a dash-dot curve. It is clear that both the write power and the erase power have a significant influence on the re-crystallization of the sides of the marks in the adjacent tracks and therefore on the final mark shape of the marks in the adjacent tracks. Possible parameters vary to obtain the desired results are the write pulse and erase pulse length and the possible cooling gap (bias level). The track pitch, the power levels and pulse duration are closely related and need therefore to be optimized in a cluster optimization algorithm.

In conclusion, the re-crystallization in the tail of the mark is mainly controlled by the write strategy to write the actual data pattern in a track (re-crystallization during write). The re-crystallization at the sides of the marks is induced when marks are written in an adjacent track (thermal cross-erase). Both processes are rather de-coupled which suggests that fine tuning and optimization of the mark shapes and sizes is possible.

Experiments were performed to demonstrate the feasibility of the principle. A conventional single layer Blu-ray Disc was used where both the lands (on-grooves) and grooves (in-grooves) were used for recording. The data track pitch of this groove-only disc was 320 nm but we used both the land and groove plateau such that we obtained a data track pitch of 160 nm. By tuning the radial off-set of both land and groove, we could stretch the track pitch to about 180-190 nm which was sufficient to perform the experiments. Recall that 185 nm was also the cell length in the tangential direction as used in the multi-level scheme.

The optical cross-talk was studied from carrier patterns written in the central track while the carrier signal was measured in the adjacent track. This resulted in a −6 dB signal reduction for an I3 carrier (from −7.3 dB to −13.3 dB) and −7.8 dB for a 111 carrier (from 0 to −7.8 dB), the values were measured with a spectrum analyzer. Both experiments illustrated that the marks in the adjacent tracks are well seen by the optical spot at 200 nm data track pitch. Written syncs, for example a data pattern consisting of long and short marks can be used to align the marks spatially. These syncs are written in a previous write cycle and need to be seen in the adjacent track when the central track is prepared for writing. This means that the flanks of the spot need to see the syncs signal as a consequence of optical cross talk.

FIG. 6 shows the signal reduction of I3 and I11 carrier written in the central track due to continuous heating of the adjacent track.

FIG. 6 shows the result of the partial re-crystallization of marks in the central track due to writing in the adjacent track. Short (I3) and long (I11) carriers were written in the central track and subsequently, a continuous erase (or write) power was applied to the adjacent track (the adjacent track was at 200 nm track pitch). The signal reduction of the I3 and I11 carrier is shown in FIG. 6 as a function of the erase power applied in the adjacent track. The linear increase in signal reduction (expressed in dB) illustrates that a higher erase power in the adjacent track leads to more partial re-crystallization of the marks present in the central track. The significant change in signal reduction indicates that variation of erase power is a way to control the partial re-crystallization, and therefore size, of the marks.

FIG. 7 shows the measured initial reflection of an I3-I11 data pattern written in a central track of a BD disc, the I3 marks represent the data, the I11 marks represent the syncs.

Further, the partial re-crystallization of marks written in the central track due to two erase levels in the adjacent track was studied. A data pattern consisting of an I3 carrier that was alternated with a synch pattern (I11) was written in the central track. The initial reflection of the central track with an I3-I11 data pattern is shown in FIG. 7. The adjacent track was subsequently heated with a block-shaped laser power, the two erase levels being Pₑᵣₐₛₑ=1.5 mW and Pₑᵣₐₛₑ=2.5 mW. The resulting track reflection is shown in FIG. 8.

FIG. 8 shows measured reflection of the I3-I11 data pattern after application of a block-shaped erasure in the adjacent track with two different erase power levels. In case the adjacent track was heated with a high laser power, more re-crystallization of the marks in the central track occurred. This resulted in smaller marks and therefore a lower reflection signal 82. If the adjacent track was heated with a lower erase power, less re-crystallization occurred and a higher reflection signal 81 resulted. This signal modulation of the I3 pattern can be clearly seen in the measured reflection signal . This experiment in principle illustrates that multi-level recording is possible by on-purpose modification of marks by thermal cross-erase.

Also some re-crystallization of the I11 synchs is observed. In 2D multi-level phase-change recording, the syncs should be mastered or the partial re-crystallization should be avoided by synchronization of the data pattern since deterioration of synchs is strictly forbidden. Even in case of mastered syncs data can be written only in between sync patterns.

The accuracy at which marks can be written in the disc is related to the timing accuracy of the write strategy and the deviation in the linear velocity of the rotating disc (drift or other variation). The linear velocity (v) relates to the angular velocity (ω) according to v=ωR, (R is radius). The angular velocity can be controlled by the application of so-called ‘tachopulses’. 250 increments per revolution results in an accuracy of δv=0.05 m/s. The syncs (mastered pits or written marks) in the disc can be used to retrieve an accurate relative time which is used to synchronize data tracks. Estimate of this uncertainty δt=0.5 ns. The uncertainty in the place position is δx=δx/δt δt+δx/δv δv=v δt+t δv, where v and δv are the linear velocity and its error, t and 8t are the elapsed time and its error. If we assume δt=0.5 ns, δv=−0.05 m/s and an elapsed time of 100 ns, we obtain at a linear velocity of 10 m/s an error of δx=10 nm. Table 1 shows the distance between two tacho pulses (250 pulses per revolution) in meter and in 185 nm cells. Assuming a sync pattern of 30T length and a maximum capacity loss due to the sync of 5%, the required coherence lengths of the cells in two adjacent tracks would be 600 cells. For an alignment accuracy of 10 run, the variation in speed should be less than 10 nm/(600*185 nm)=9e−5 or 0.0009 m/s (at 10 m/s). The timing accuracy should be better than 1 ns.

| Disc radius | Circumference | Distance of tacho | |
|---|---|---|---|
| [mm] | [m] | pulses [m] | # Cells |
| 10 | 0.0628 | 0.0002512 | 1358 |
| 60 | 0.37681 | 0.0015072 | 8147 |

The analysis of the alignment accuracy for adjacent tracks is important and should be carried out in more detail in the near future.

The different laser spots needs to be modulated separately to enable the writing of a two-dimensional mark pattern in the medium. The channel bit length can be chosen 160-180 nm. The proper selection of the length and power of the write pulse enable the controlled writing of marks in the track. The length and laser power of the erase pulse cause the controlled re-crystallization in the tangential direction. In this way, a two-dimensional multi-level data pattern can be written.

A grating can be used to create multiple spots. A far-field modulator placed directly behind the grating is still needed to modulate the laser power in the different spots. It is also possible to use a laser diode with several cavities aligned at close proximity. These different laser sources can be individually powered to deliver a modulated laser beam, similar as is done in laser diodes with one emitting source.

1. Method of recording information on an optical disc comprising irradiating a first region of the optical disc with a first dose of optical energy, irradiating a first portion of the first region with a second dose of optical energy in a manner that causes the first portion of the first region irradiated with the second dose of optical energy to be in a different state than a second portion of the first region that is not irradiated by the second dose of optical energy, characterized in that a third portion of the first region which is comprised in the second portion of the first region, where the third portion is adjacent to the second region, is irradiated with a third dose of optical energy when a portion of a second region which is adjacent to the first region is irradiated with the third dose of optical energy in a manner that causes the third portion of the first region irradiated with the third dose of optical energy to be in a different state than the second portion of the first region that is not irradiated by the third dose of optical energy.

2. Method of recording information on an optical disc as claimed in claim 1, characterized in that the third dose of optical energy is adjusted to control a size of the third portion of the first region.

3. Method of recording information on an optical disc as claimed in claim 1, characterized in that the third dose of optical energy is adjusted to control a size of the second portion of the first region.

4. Method of recording information on an optical disc as claimed in claim 1, characterized in that the second region is located adjacent to the first region in a direction perpendicular to a writing direction.

5. Method of recording information on an optical disc as claimed in claim 4, characterized in that the first region is located on a first track and the second region is located on a second track which is adjacent to the first track.

6. Write strategy processor arranged to generate control signals for writing data to an optical disc comprising a processor arranged to specify a first optical pulse for irradiating a first region of the optical disc with a first dose of optical energy and a second optical pulse for irradiating a first portion of the first region with a second dose of optical energy in a manner that causes the first portion of the first region irradiated with the second optical dose to be in a different state than a second portion of the first region that is not irradiated by the second dose of optical energy, characterized in that the processor is arranged to specify a third optical pulse for irradiating a second region of the optical disc, adjacent to the first region, such that a third portion of the first region where the third portion is adjacent to the second region, comprised in the second portion of the first region, is also irradiated with a third optical dose in a manner that causes the third portion of the first region irradiated with the third optical dose to be in a different state than a second portion of the region that is not irradiated by the second dose of optical energy.

7. Optical disc obtained using the method of claim 1.

8. Recorder for recording optical discs comprising a write strategy processor as claimed in claim 6.

9. Method of recording information on an optical disc as claimed in claim 1, characterized in that a first optical beam is used to irradiate the first region while a second optical beam is used of irradiate the second region.

10. Method of recording information on an optical disc as claimed in claim 9, characterized in that a first optical beam is offset in the writing direction from the second optical beam.

11. Method of recording information on an optical disc as claimed in claim 10, characterized in that the offset between the first optical beam and the second optical beam is related to a thermal interference between the first region and the second region.
